(19) United States
(12) Patent Application Publication
(10) Pub. No.: US 2016/0366261 A1
(43) Pub. Date: Dec. 15, 2016

(54) PHONE CALL RECORDING FUNCTIONALITY VIA A MOBILE DATA PROCESSING APPARATUS

(71) Applicant: DSS Corp, Southfield, MI (US)

(72) Inventors: Matt Carter, Ypsilanti, MI (US); Joe Mosed, Beaverton, OR (US)

(21) Appl. No.: 14/737,441

(22) Filed: Jun. 11, 2015

(51) Int. Cl. H04M 1/65; H04L 12/18; H04W 4/02

(52) U.S. Cl. CPC H04M 1/65; H04W 4/025; H04L 12/1831

(57) ABSTRACT

An information capture system comprises a plurality of mobile data processing apparatuses and a recorded call information server. Each one of the mobile data processing apparatuses is configured for generating party-notified phone conversation recordings. Generating each one of the party-notified phone conversation recordings includes determining recording consent notification requirements based upon a location of at least one party engaged in a respective one of the phone conversations and issuing recording consent notification in accordance with the consent notification requirements. The recorded call information server is coupled to each one of the mobile data processing apparatuses for monitoring call recording activity of each one of the mobile data processing apparatuses. Monitoring the call recording activity includes receiving a location of a particular one of the mobile data processing apparatuses during an instance of a phone call.

### FIELD OF THE DISCLOSURE

The disclosures made herein relate generally to mobile data processing apparatus functionality and, more particularly, to implementing phone call recording on a mobile data processing apparatus.

### BACKGROUND

Cellular telephones, which are a type of mobile data processing apparatus also referred to as smartphones, have become commonplace in today's society. Their portability and ready accessibility has made them a preferred means of information capture and communication for both personal and professional usage. In this respect, cellular telephones are regularly used for capturing and sharing digital images, communicating via text (i.e., text messaging), and communicating via voice (i.e., phone calls).

Call recording on a cellular telephone as well as on similar mobile data processing apparatus is a functionality that can be very useful and even essential to certain users and in certain applications and situations. One particularly application is capturing of evidence by law enforcement officers. For example, a law enforcement office may have a need record a phone call with an individual having knowledge relating to known or alleged criminal activity. For such a recorded phone call to be useful such as for example as admissible evidence in a court proceeding, that recording must have been recorded in a manner that adheres to applicable requirement(s) of the law.

Therefore, a system-implemented solution for recording phone calls via a mobile data processing apparatus in a manner that adheres to applicable requirement(s) of the law automatically without user intervention is would be advantageous, desirable and useful.

### SUMMARY OF THE DISCLOSURE

Embodiments of the inventive subject matter are directed to recording phone calls (i.e., telephonic conversations) via a mobile data processing apparatus in a manner that adheres to applicable requirement(s) of the law automatically without user intervention. More specifically, preferred embodiments of the inventive subject matter are directed to system-implemented functionalities in a mobile data processing apparatus (e.g., a smart phone) that govern the need for and manner in which one or more parties involved in a call are notified that the call is being recorded, thereby ensuring that the recording has been made in accordance with any applicable laws. In this respect, embodiments of the inventive subject matter are beneficial in the situation of a law enforcement officer's needs to record a phone call that may be used as evidence in court. For such a recording to be admissible in court, there are instances where such recording must have been made in accordance with certain applicable laws.

In an embodiment of the inventive subject matter, a process is performed by a mobile data processing apparatus for enabling a conversation to be recorded. The process includes a plurality of operations. An operation is performed for determining recording consent notification requirements based upon a location of at least one to-be-recorded party engaged in a phone call to which the mobile data processing apparatus is connected. An operation is performed for generating a recording of a conversation of the phone call in conjunction with issuing recording consent notification to the at least one to-be-recorded party in accordance with the consent notification requirements. Thereafter, an operation is performed for transmitting the recording of the phone call conversation for reception by a recorded call information server.

In another embodiment of the inventive subject matter, a mobile data processing apparatus comprises a non-transitory computer-readable medium and at least one processor. The non-transitory computer-readable medium accesses an application for implementing a process of generating party-notified phone conversation recordings. The at least one processor is coupled to the non-transitory computer-readable medium for implementing the process of generating party-notified phone conversation recordings. Implementing the process of generating party-notified phone conversation recordings includes determining recording consent notification requirements based upon a location of at least to-be-recorded party engaged in a respective one of the phone conversations and issuing recording consent notification to the at least to-be-recorded party in accordance with the consent notification requirements.

In another embodiment of the inventive subject matter, an information capture system comprises a plurality of mobile data processing apparatuses and a recorded call information server. Each one of the mobile data processing apparatuses is configured for generating party-notified phone conversation recordings. Generating each one of the party-notified phone conversation recordings includes determining recording consent notification requirements based upon a location of at least one party engaged in a respective one of the phone conversations and issuing recording consent notification in accordance with the consent notification requirements. The recorded call information server is coupled to each one of the mobile data processing apparatuses for monitoring call recording activity of each one of the mobile data processing apparatuses. Monitoring the call recording activity includes receiving a location of a particular one of the mobile data processing apparatuses during an instance of a phone call.

These and other objects, embodiments, advantages and/or distinctions of the inventive subject matter will become readily apparent upon further review of the following specification, associated drawings and appended claims.

### BRIEF DESCRIPTION OF THE DRAWINGS

FIG. 1 is a flow diagram showing a system-implemented method for carrying out call information capture functionality in accordance with an embodiment of the inventive subject matter

FIG. 2 is a block diagram showing an information capture system configured in accordance with an embodiment of the inventive subject matter.

FIG. 3 is a diagrammatic view showing a client log configured in accordance with an embodiment of the inventive subject matter.

FIG. 4 is a diagrammatic view showing a recorded call information summary for a selected one of the entries in the client log of FIG. 3.

FIG. 5 is a diagrammatic view showing a user rights summary for a selected one of the entries in the client log of FIG. 3.

FIG. 6 shows a diagrammatic showing a data processing apparatus configured in accordance with an embodiment of the inventive subject matter.

### DETAILED DESCRIPTION

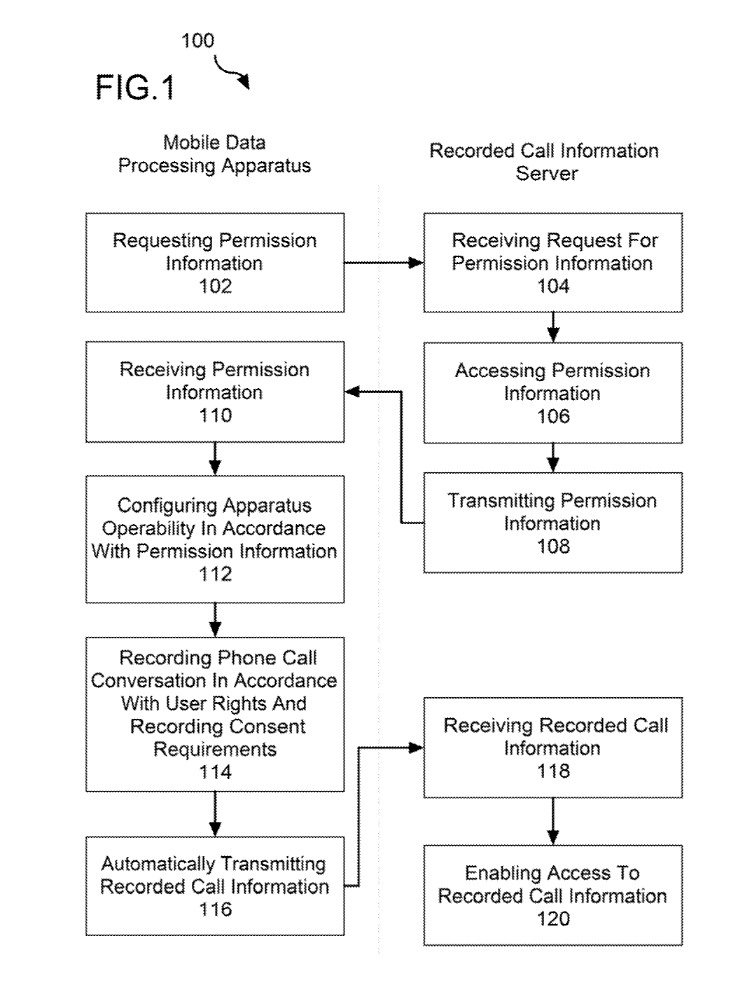

FIG. 1 is a flow diagram showing a system-implemented method (i.e., method 100) for carrying out call information capture functionality in accordance with an embodiment of the inventive subject matter. The method 100 is preferably implemented via a call recording system comprising, for example, one or more mobile data processing apparatuses and one or more recorded call information servers. Call information capture functionality in accordance with embodiments of the inventive subject matter enables a phone conversation to be recorded at a mobile data processing apparatus (i.e., a first computer) in a manner that adheres to applicable requirement(s) of the law automatically without user intervention and enables the recorded phone conversation and associated information (i.e., recorded phone call information) to be automatically transmitted for reception, storage, processing by a recorded call information server (i.e., a second computer).

A server, which is running an application (i.e., a set of instructions) configured in accordance an embodiment of the inventive subject matter, is an example of the recorded call information server. An Apple iPhone brand cellular telephone and a cellular phone with an Android brand operating system, which are running an application (i.e., a set of instructions) configured in accordance an embodiment of the inventive subject matter, are each examples of a mobile data processing apparatus, which is commonly referred to as “smart phones”. A smart phone and similarly capable types of tablets and notepads are each an example of a mobile data processing apparatus (i.e., a type of computer) in the context of embodiments of the inventive subject matter.

The method 100 begins with an operation 102 being performed by a mobile data processing apparatus for requesting permission information (i.e., a call recording permission information request) from a recorded call information server. Such request can be express or inferred. For example, the request can be an express request issued by the mobile data processing apparatus from having the permission information provided. Optionally, for example, an initial visibility of the mobile data processing apparatus by the recorded call information server can be inferred as a request issued by the mobile data processing apparatus from having the permission information provided (e.g., upon initial registration of an application running on the mobile data processing apparatus for providing call information capture functionality). In response to receiving the permission information request, the recorded call information server performs an operation 104 for receiving the permission information request, followed by the recorded call information server performing an operation 106 for accessing the permission information and an operation 108 for transmitting the permission information for reception by the mobile data processing apparatus. In preferred embodiments, signal transmission between the mobile data processing apparatus and the recorded call information server can be implemented via Internet connectivity. However, embodiments of the inventive subject matter are not limited to any particular manner in which signal transmission between the mobile data processing apparatus and the recorded call information server can be implemented.

In response to the mobile data processing apparatus performing an operation 110 for receiving the permission information, an operation 112 is performed by the mobile data processing apparatus for configuring its operability (i.e., device operability) in accordance with the permission information, which can include applying permissions accordingly and configuring user rights accordingly. In preferred embodiments, an application running on the mobile data processing apparatus (i.e., client application) for enabling client-based portions of the call information capture functionality has no user right settings that can be altered by a user of the mobile data processing apparatus from the mobile data processing apparatus. Rather, the permission information received from the recorded call information server serves to “unlock” functionality on the phone application. To this end, by configuring user rights in accordance with the permission information, the mobile data processing apparatus is capable of implementing client application tasks of the call information capture functionality as governed by the user rights. Examples of permissions associated with the client application include, but are not limited to, one or more permission directed to reading phone status and identity, one or more permissions directed to recording audio, one or more permissions directed to obtaining location-defining information (e.g., global positioning system (GPS) data), one or more permissions directed to reading contact information, one or more permissions directed to allowing full network access, one or more permissions directed to the client application running as background service. Examples of user rights include, but are not limited to, a right for allowing recording of a call to be selectively activated and deactivated through use of the mobile data processing apparatus, a rights for allowing capture of a location of the mobile data processing apparatus during recording of a call to be selectively activated and deactivated through use of the mobile data processing apparatus, a right for allowing a call to be recorded immediately upon demand, and the like.

The operations 102-112 are referred to herein as device configuration functionality. Such device configuration functionality can be implemented performed upon initial installation of the client application on the mobile data processing apparatus (i.e., initial device configuration). Additionally, as a skilled person will appreciate, such device configuration functionality can be implemented at one or more other times after the initial device configuration. In one example, instances of device configuration functionality can be carried out periodically after the initial device configuration (e.g., at a prescribed time interval after initial device configuration), upon command by the recorded call information server (e.g., in response to a change in permission information made at the recorded call information server), or the like.

After the device operability has been configured in accordance with the permission information, the mobile data processing apparatus performs an operation 114 for recording a conversation (i.e., a call) between a user of the mobile data processing apparatus and one or more connected parties. The recorded conversation is an example of recorded call information. Other examples of recorded call information include, but are not limited to, a physical location (e.g., civic address) of the mobile data processing apparatus when the conversation between the user of the mobile data processing apparatus and the one or more connected parties was recorded, a geo-spatial location (e.g., latitude and longitudinal coordinates) of the mobile data processing apparatus when the conversation between the user of the mobile data processing apparatus and the one or more connected parties was recorded, a unique identifier of the mobile data processing apparatus, a unique identifier of a respective communication device of at least one of the one or more connected parties, a time at which the call was connected, a duration of the call, and the like.

In preferred embodiments, recording a conversation (i.e., a call) between a user of the mobile data processing apparatus and one or more connected parties includes provisions for ensuring that there is express intent for such recording to have been implemented in a manner that adheres to applicable requirement(s) of the law. Preferably, such provisions are determined and implemented automatically without user intervention upon initiation of connection to the communication device of at least one of the one or more connected parties. One example of such provisions is determination of privacy requirement(s) and/or other legal requirement(s) of the one or more connected parties. Another example of such provisions is automated delivery of a notification that the call is being recorded or will be recorded to the communication device of at least one of the one or more connected parties, based at least partially dependent upon such privacy requirement(s). In this respect, a phone conversation recorded in accordance with embodiments of the inventive subject matter is preferably a party-notified phone conversation recording.

Consent to record a telephone conversation is one requirement of law (privacy or otherwise) that is sometimes necessary for a phone conversation to be legally recorded. Legal recording is often crucial as it enables such conversation to be used as evidence by a law enforcement entity during a judicial proceeding involving parties that participated in the call (e.g., a law enforcement officer, one or more alleged criminals, one or more alleged witnesses, or the like). Some jurisdictions (e.g., United States such as California, Connecticut, Florida, Maryland, Massachusetts, New Hampshire, Pennsylvania, and Washington) require that all parties to a recorded phone conversation (i.e., to-be-recorded parties) consent to a recording of such conversation and are, thus, commonly referred to as “All-Party Consent Jurisdictions”. Other jurisdictions (e.g., nearly all other states in the United States that are not an All-Party Consent Jurisdiction) strictly or typically (e.g., aside from stated exceptions) adhere to the requirement that only one connected party to a recorded phone conversation (one to-be-recorded party) consent to a recording of such conversation and are, thus, commonly referred to as “One-Party Consent Jurisdictions”. For clarity, the person in control of the mobile data processing apparatus being used to record a conversation in a phone call is also referred to herein as the recording party.

In this respect, a skilled person will appreciate that the client application can be configured to automatically determine if the one or more parties to the call are in a one-party consent jurisdiction or an all-party consent jurisdiction. The application will do this based on location of the callers and the phone numbers associated with each of the mobile apparatuses participating in the call. This two-step process will preferably not require user intervention (i.e., will be performed automatically) upon each to-be-recorded party being connected to the phone call. One approach for determining if a party to a call (i.e., the caller) is in a one-party consent jurisdiction or an all-party consent jurisdiction includes using an area code of a phone number of the caller to determine a city and state at which the phone number is registered (cellular phone and land lines) and/or physically located (land line). Another approach for determining if a party to a call (i.e., the caller) is in a one-party consent jurisdiction or an all-party consent jurisdiction includes using currently available technologies/methods (e.g., cell tower transponder ping) or those technologies/methods yet to be developed to determine a geographic location at which a cellular phone of the caller is physically located. Such an automated process is very important as it eliminates the element of human error. In response to such determination, the client application will issue a consent notification accordingly and will thereafter initiate recording of the phone call upon receipt of necessary consent (e.g., from one or more to-be-recorded parties in a one-party consent jurisdiction and from all to-be-recorded parties in an all-party consent jurisdiction). In the case of cross-jurisdiction phone call, call consent will be implemented in accordance with the most-restriction consent requirements (e.g., requirements of an all-party consent jurisdiction).

It is disclosed herein that embodiments of the inventive subject matter can be configured to allow for certain override functionality as it relates to consent to record. Such override functionality (e.g., via a corresponding permission) is useful because there are certain circumstances where law enforcement officers are not required to announce that they are recording a phone call. As such, an ability to selectively override call recording notification can be useful.

In some implementations of call information capture functionality in accordance with embodiments of the inventive subject matter, information defining a current location of the mobile data processing apparatus and/or information defining location of the communication device of one or more connected parties is used for determining privacy requirement(s) and/or other legal requirement(s) necessary to be implemented to show intent that a conversation between the user of the mobile data processing apparatus and the one or more connected parties was recorded in a manner that adheres to such privacy requirement(s) and/or other legal requirement(s). Thereafter, necessary functions are at the onset of and/or during the call pursuant to such privacy requirement(s) and/or other legal requirement(s). For example, as required by some laws, a notification that the call will be recorded is provided to the one or more connected parties prior to such recording being initiated and a notification is made at regular intervals during the call to acknowledge that such recording is taking place. A verbal (i.e., oral) message presented to parties connected in a phone call prior to recording of a conversation to which they are participants is a common mode of notification that the call will be recorded (i.e., providing consent notification). In some embodiments (e.g., in the case of a party in a call being in an All-Party Consent Jurisdictions), consent notification can include a consent notification being sent via test message or other similar form of instant messaging. An audible tone (e.g., beep) presented after the verbal message at regular intervals during the call is a common mode of notification that the call is being recorded.

In response to recording the conversation, an operation 116 is performed by the recorded call information associated with the recorded conversation is transmitted to the recorded call information server. In preferred embodiments, transmitting the recorded conversation to the recorded call information server is performed in response to termination of the connection between the mobile data processing apparatus and the communication device of each one of the one or more connected parties. In preferred embodiments, transmitting the recorded conversation to the recorded call information server is performed automatically without any intervention by a user of the mobile data processing apparatus.

After the recorded call information server performs an operation 118 for receiving the recorded call information from the mobile data processing apparatus, the recorded call information server performs an operation 120 for enabling access to the recorded call information. Examples of enabling access to the recorded call information include, but are not limited to, storing the recorded call information, displaying a system device summary including the recorded call information for later retrieval, monitoring location of location-enabled mobile data processing apparatuses, displaying a call summary including the recorded call information, providing a real-time view of recorded call information as it is being received, and the like.

Although the description of the method 100 uses a mobile data processing apparatus (e.g., a smart phones) as the exemplary device through which call information capture functionality is implemented, it is disclosed herein that one or more other types of data processing apparatuses can be used for implementing call information capture functionality. Examples of such other types of data processing apparatuses include, but are not limited to tablets, voice over internet Protocol (VOIP) phones, laptop computers, vehicle integrated communication systems, and the like.

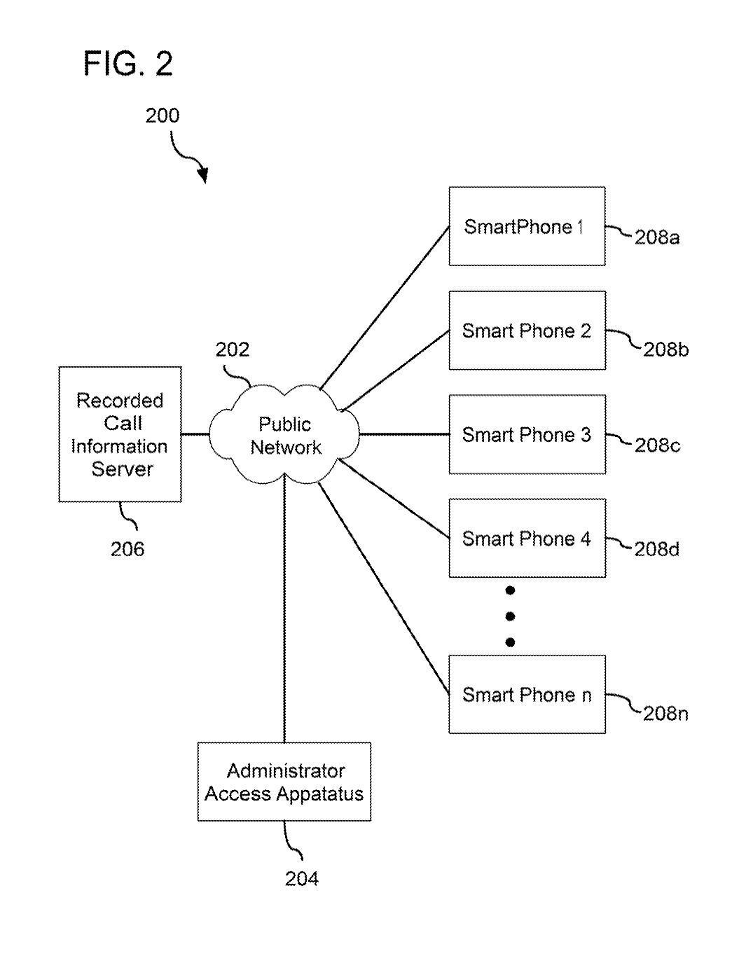

Turning now to FIG. 2, an information capture system 200 configured in accordance with an embodiment of the inventive subject matter is shown. The information capture system 200 includes a public network 202 such as the Internet, an administrator access apparatus 204, a recorded call information server 206, and a plurality of call capture apparatuses 208a-208n. The administrator access apparatus 204 and the plurality of call capture apparatuses 208a-208n are coupled to the recorded call information server 206 via the public network 202.

The recorded call information server 206 and the plurality of call capture apparatuses 208a-208n are jointly configured for carrying out call information capture functionality in accordance with embodiments of the inventive subject matter. For example, the recorded call information server 206 can have a server application running thereon and each one of the call capture apparatuses 208a-208n can have a respective instance of a client application running thereon. In this respect, each client application and the server application allows a respective instance of call information capture functionality disclosed above in reference to FIG. 1 to be implemented. It is disclosed herein that the information capture system can also be configured to capture text information, video information, text message information, multi-media message information, email information, and other types of information capable of being communication between data processing apparatuses.

The administrator access apparatus 204 is a data processing apparatus (workstation, computer, or the like) capable of accessing the server application running on the recorded call information server 206. Such access can be provided through the public network 202 (shown) and/or can be provided through direct connection of the administrator access apparatus 204 to the recorded call information server 206 (not shown). Through such access to the server application running on the recorded call information server 206 a user can accomplish a variety of call information capture functionality actions.

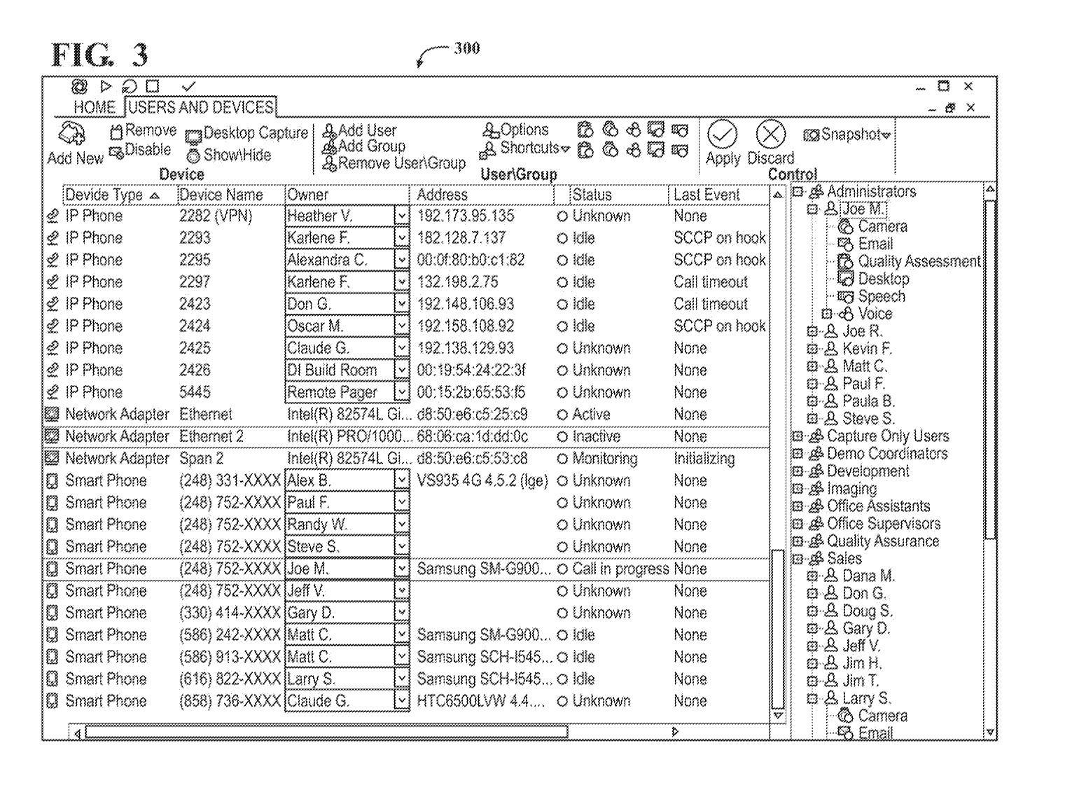

One such call information capture functionality action is accessing a recorded call information log showing real-time or static state of each one of the call capture apparatuses 208a-208n. For example, as shown in FIG. 3, an administrator can access a client log 300 that provides device-specific information for each one of the call capture apparatuses within an associated information capture system. Examples of such device-specific information include, but are not limited to, device type, a unique device identifier, device owner, unique device network address, current device status, and last known event for the device.

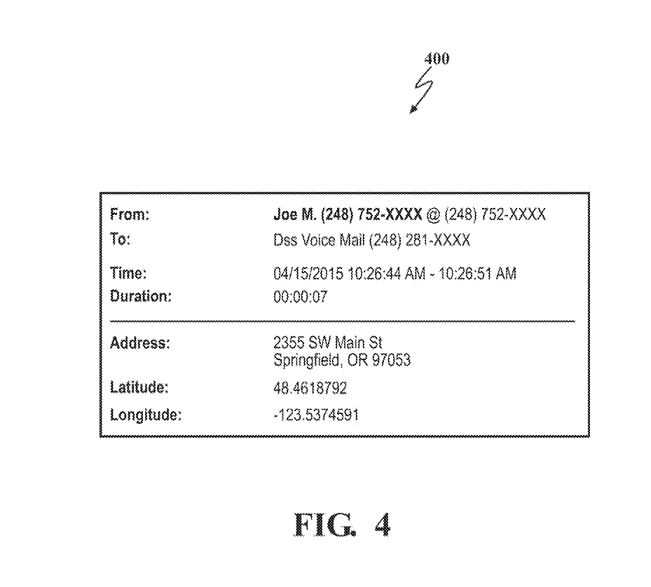

Another such call information capture functionality action is accessing a recorded call information summary for a particular one of the entries in the client log 300. FIG. 4 shows an example of a recorded call information summary 400 for a selected one of the entries (i.e., devices) in the client log 300. The recorded call information summary 400 provides device-specific information for a selected one of the entries in the client log 300. Examples of such device-specific information in the recorded call information summary 400 include, but are not limited to, name of device user, device identifying information (e.g., device phone no.), connected party identifying information (e.g., party name and phone no.), last event time, last event date, last event duration, geo-spatial location of device during last event, civic address of device during last event, and the like. In this respect, embodiments of the inventive subject matter allow real-time monitoring and/or periodic monitoring of activity (i.e., call information, location information, and the like) of all or a portion of the call capture apparatuses 208a-208n.

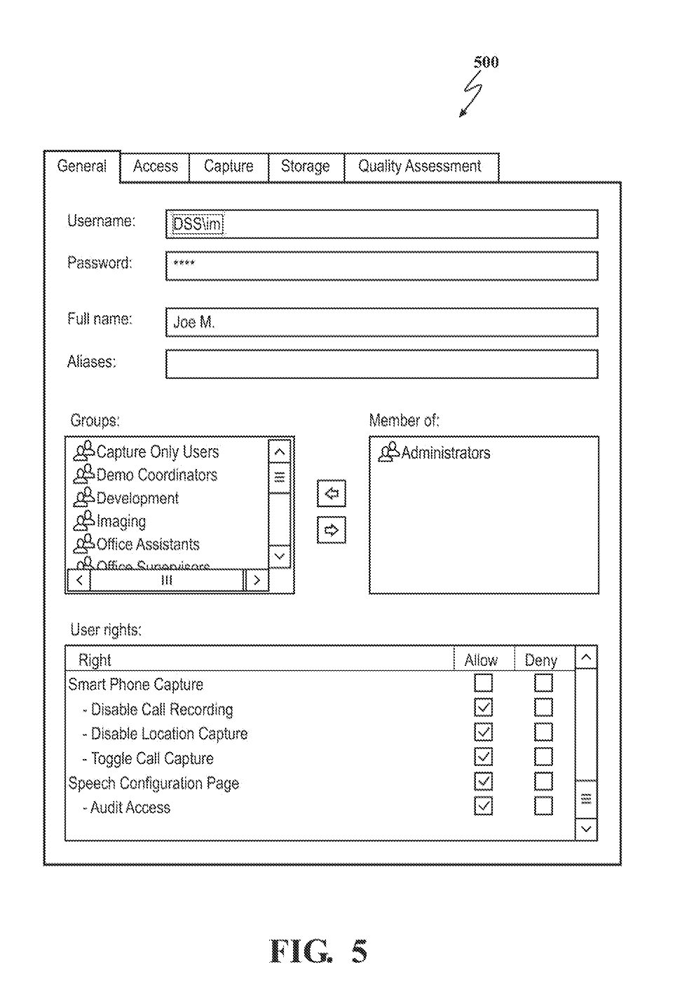

Still another such call information capture functionality action is accessing user rights list through which associated permissions for a particular one of the entries in the client log 300 can be set. FIG. 5 shows an example of a user rights summary 500 for a selected one of the entries (i.e., devices) in the client log 300. The user rights summary 500 allows user rights for a selected one of the entries in the client log 300 to be selectively allowed and denied. Examples of such user rights include, but are not limited to, rights relating to device capture functions (e.g., allowing the user to shut off/turn on call recording, allowing the user to shut off/turn on location capture, and allowing the user to record a call on demand when it is in progress if the call recording is turned off) and rights relating to speech configuration and audit access. Speech configuration refers to functionality processing of recorded phone calls within an information capture system using speech recognition such as to search by words and phrases that were said within a conversation in the recorded phone call. Audit access refers to being able to determine who has accessed recorded call information (e.g., searching, reporting, seeing call data) within an information capture system.

In preferred embodiments of the present invention, access to recorded call information within an information capture system is provided via a browser front end. Such a browser front end can be configured for allowing authorized users (e.g., a system administrator) to search calls, play calls and report on recorded call data. Beneficially, such a browser front end allows authorized users to access the recorded call information (e.g., search and play recorded calls) from any suitably configured device (e.g., tablet, computer, smart phone etc).

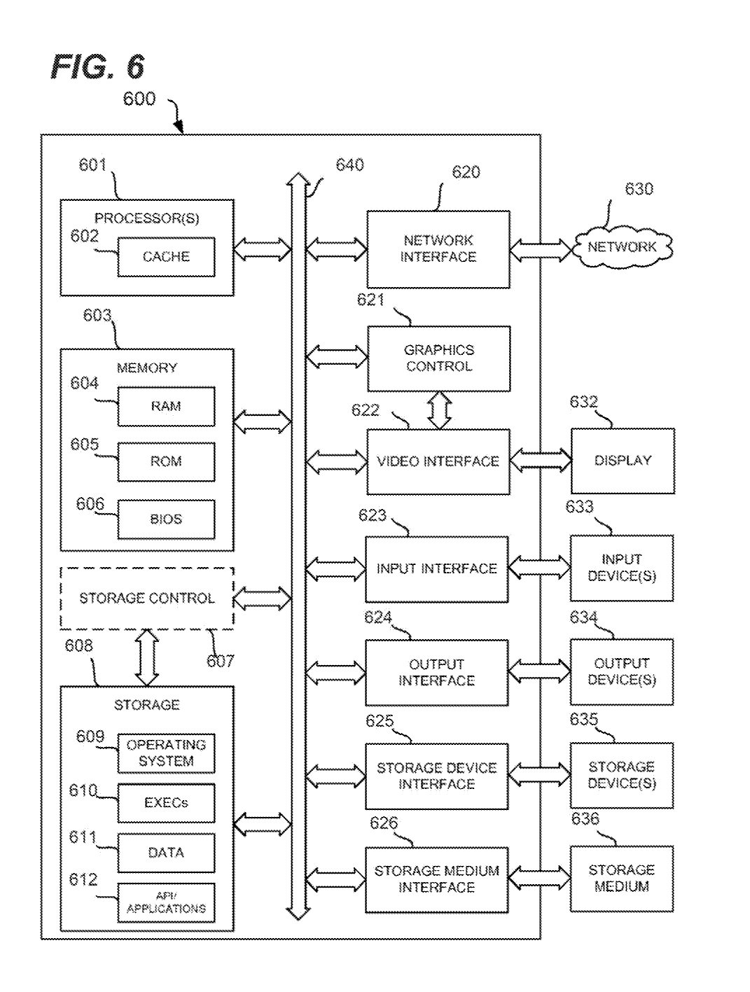

Turning now to a discussion of approaches for implementing embodiments of the inventive subject matter, systems and methods in accordance with embodiments of the inventive subject matter can be implemented in any number of different types of data processing apparatus (e.g., a server, a smart phone, and the like). To this end, FIG. 6 shows a diagrammatic representation of one embodiment of a data processing apparatus 600 within which a set of instructions can execute for causing a device to perform or execute any one or more of the aspects and/or methodologies of the present disclosure. The components in FIG. 6 are examples only and do not limit the scope of use or functionality of any hardware, software, embedded logic component, or a combination of two or more such components implementing particular embodiments.

The data processing apparatus 600 can include a processor 601, a memory 603, and a storage 608 that communicate with each other, and with other components, via a bus 640. The bus 640 can also link a display 632, one or more input devices 633 (which can, for example, include a keypad, a keyboard, a mouse, a stylus, etc.), one or more output devices 634, one or more storage devices 635, and various tangible storage media 636. All of these elements can interface directly or via one or more interfaces or adaptors to the bus 640. For instance, the various tangible storage media 636 can interface with the bus 640 via storage medium interface 626. Data processing apparatus 600 can have any suitable physical form, including but not limited to one or more integrated circuits (ICs), printed circuit boards (PCBs), mobile handheld devices (such as mobile cellular telephones, tablets, or personal digital assistants (PDAs)), laptop or notebook computers, distributed computer systems, computing grids, or servers. All or a portion of the elements 601-636 can be housed in a single unit (e.g., a smart phone housing, a tablet housing, or the like).

Processor(s) 601 (or central processing unit(s) (CPU(s))) optionally contains a cache memory unit 602 for temporary local storage of instructions, data, or computer addresses. Processor(s) 601 are configured to assist in execution of computer readable instructions (i.e., a set of instructions). Data processing apparatus 600 can provide functionality as a result of the processor(s) 601 executing software embodied in one or more tangible computer-readable storage media, such as memory 603, storage 608, storage devices 635, and/or storage medium 636. The computer-readable media can store software that implements particular embodiments of the inventive subject matter, and processor(s) 601 can execute the software. Memory 603 can read the software from one or more other computer-readable media (such as mass storage device(s) 635, 636) or from one or more other sources through a suitable interface, such as network interface 620. The software can cause processor(s) 601 to carry out one or more processes or one or more steps of one or more processes described or illustrated herein. Carrying out such processes or steps can include defining data structures stored in memory 603 and modifying the data structures as directed by the software.

The memory 603 can include various components (e.g., machine readable media) including, but not limited to, a random access memory component (e.g., RAM 604) (e.g., a static RAM “SRAM”, a dynamic RAM “DRAM, etc.), a read-only component (e.g., ROM 605), and any combinations thereof. ROM 605 can act to communicate data and instructions unidirectionally to processor(s) 601, and RAM 604 can act to communicate data and instructions bidirectionally with processor(s) 601. ROM 605 and RAM 604 can include any suitable tangible computer-readable media described below. In one example, a basic input/output system 606 (BIOS), including basic routines that help to transfer information between elements within data processing apparatus 600, such as during start-up, can be stored in the memory 603.

Fixed storage 608 is connected bidirectionally to processor(s) 601, optionally through storage control unit 607. Fixed storage 608 provides additional data storage capacity and can also include any suitable tangible computer-readable media described herein. Storage 608 can be used to store operating system 609, EXECs 610 (executables), data 611, APV applications 612 (application programs), and the like. Often, although not always, storage 608 is a secondary storage medium (such as a hard disk) that is slower than primary storage (e.g., memory 603). Storage 608 can also include an optical disk drive, a solid-state memory device (e.g., flash-based systems), or a combination of any of the above. Information in storage 608 can, in appropriate cases, be incorporated as virtual memory in memory 603.

In one example, storage device(s) 635 can be removably interfaced with data processing apparatus 600 (e.g., via an external port connector (not shown)) via a storage device interface 625. Particularly, storage device(s) 635 and an associated machine-readable medium can provide nonvolatile and/or volatile storage of machine-readable instructions, data structures, program modules, and/or other data for the data processing apparatus 600. In one example, software can reside, completely or partially, within a machine-readable medium on storage device(s) 635. In another example, software can reside, completely or partially, within processor(s) 601.

Bus 640 connects a wide variety of subsystems. Herein, reference to a bus can encompass one or more digital signal lines serving a common function, where appropriate. Bus 640 can be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Preferably, the data processing apparatus 600 is configured to determine a location at which it is currently positioned. To this end, the data processing apparatus 600 can include a set of instructions for determining such location. A Global Positioning System (GPS) application accessible from within storage and/or memory of the data processing apparatus 600 (e.g., as an application accessible from within the storage 508) is an example of such a set of instructions for determining such location. In some embodiments, the set of instructions for determining such location cause at least a portion of information necessary for determining such location, to be obtained from an external apparatus or system (e.g., via a network connection). Preferably, the location can be provided in the form of coordinates and/or a civic address.

Data processing apparatus 600 can also include an input device 633. In one example, a user of data processing apparatus 600 can enter commands and/or other information into data processing apparatus 600 via input device(s) 633. Examples of an input device(s) 633 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 633 can be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when data processing apparatus 600 is connected to network 630, data processing apparatus 600 can communicate with other devices, specifically mobile devices and enterprise systems, connected to network 630. Communications to and from data processing apparatus 600 can be sent through network interface 620, for example, network interface 620 can receive incoming communications (such as requests or responses from other devices) in the form of one or more packets (such as Internet Protocol (IP) packets) from network 630, and data processing apparatus 600 can store the incoming communications in memory 603 for processing. Data processing apparatus 600 can similarly store outgoing communications (such as requests or responses to other devices) in the form of one or more packets in memory 603 and communicated to network 630 from network interface 620. Processor(s) 601 can access these communication packets stored in memory 603 for processing.

Examples of the network interface 620 include, but are not limited to, a network interface card, a modem, and any combination thereof. Examples of a network 630 or network segment 630 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 630, can employ a wired and/or a wireless mode of communication. In general, any network topology can be used.

Information and data can be displayed through a display 632. Examples of a display 632 include, but are not limited to, a liquid crystal display (LCD), an organic liquid crystal display (OLED), a cathode ray tube (CRT), a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621.

In addition to a display 632, data processing apparatus 600 can include one or more other peripheral output devices 634 including, but not limited to, an audio speaker, a printer, and any combinations thereof. Such peripheral output devices can be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, data processing apparatus 600 can provide functionality as a result of logic hardwired or otherwise embodied in a circuit, which can operate in place of or together with software to execute one or more processes or one or more steps of one or more processes described or illustrated herein. Reference to software in this disclosure can encompass logic, and reference to logic can encompass software.

Moreover, reference to a computer-readable medium (also sometimes referred to as machine-readable medium” can encompass a circuit (such as an IC) storing software for execution, a circuit embodying logic for execution, or both, where appropriate. The present disclosure encompasses any suitable combination of hardware, software, or both.

The term “computer-readable medium” should be understood to include any structure that participates in providing data that can be read by an element of a computer system. Such a medium can take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

Those of skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each, particular application, but such implementation decisions should not be interpreted as causing a departure from the scope of the inventive subject matter.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware-components, or any combination designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium can be integral to the processor. The processor and the storage medium can reside in an ASIC. The ASIC can reside in a user terminal in the alternative, the processor and the storage medium can reside as discrete components in a user terminal.

The previous description of the disclosed embodiments is provided to enable any person skilled in the art to make or use the inventive subject matter. Various modifications to these embodiments will be readily apparent to those skilled in the art, and the generic principles defined herein can be applied to other embodiments without departing from the spirit or scope of the inventive subject matter. Thus, the inventive subject matter is not intended to be limited to the embodiments shown herein but is to be accorded the widest scope consistent with the principles and novel features disclosed herein.

Although the inventive subject matter has been described with reference to several exemplary embodiments, it is understood that the words that have been used are words of description and illustration, rather than words of limitation. Changes can be made within the purview of the appended claims, as presently stated and as amended, without departing from the scope and spirit of the inventive subject matter in all its aspects. Although the inventive subject matter has been described with reference to particular means, materials and embodiments, the inventive subject matter is not intended to be limited to the particulars disclosed; rather, the inventive subject matter extends to all functionally equivalent technologies, structures, methods and uses such as are within the scope of the appended claims.

What is claimed is:

1. A process performed by a mobile data processing apparatus for enabling a conversation to be recorded, comprising:
determining recording consent notification requirements based upon a location of at least one to-be-recorded party engaged in a phone call to which the mobile data processing apparatus is connected;
generating a recording of a conversation of the phone call in conjunction with issuing recording consent notification to the at least one to-be-recorded party in accordance with the consent notification requirements; and
transmitting the recording of the phone call conversation for reception by a recorded call in formation server.

2. The process of claim 1 wherein:
determining recording consent notification requirements based upon a location of at least one to-be-recorded party engaged in a phone call to which the mobile data processing apparatus is connected includes determining that there are a plurality of to-be-recorded parties engaged in the phone call to which the mobile data processing apparatus is connected; and
issuing the recording consent notification in accordance with consent requirements of an all-party consent jurisdiction in response to determining that at least one of the to-be-recorded parties is located in an all-party consent jurisdiction.

3. The process of claim 2 wherein determining the recording consent notification requirements is performed for each one of the to-be-recorded parties without human intervention upon the each one of the to-be-recorded parties being connected to the phone call.

4. The process of claim 1 wherein determining recording consent notification requirements includes determining a consent jurisdiction of the at least one to-be-recorded party.

5. The process of claim 1 wherein determining the recording consent notification requirements includes determining at least one of a location of the mobile data processing apparatus during the phone call and a jurisdiction corresponding to a phone number of the at least one to-be-recorded party.

6. The process of claim 1 wherein determining the recording consent notification requirements is performed without human intervention upon the at least one to-be-recorded party being connected to the phone call.

7. The process of claim 6 wherein determining recording consent notification requirements includes determining a consent jurisdiction of the at least one to-be-recorded party.

8. The process of claim 7 wherein determining the recording consent notification requirements includes determining at least one of a location of the mobile data processing apparatus during the phone call and a jurisdiction corresponding to a phone number of the at least one to-be-recorded party.

9. The process of claim 1 wherein transmitting the recording of the conversation for reception by a recorded call information server is performed automatically without human intervention.

10. The process of claim 1, further comprising:
receiving call recording permission information from the recorded call information server; and
configuring one or more controls of the mobile data processing for enabling a user to selectively initiate and terminate recording of the conversation of the phone call

11. The process of claim 10 wherein;
determining recording consent notification requirements based upon a location of at least one to-be-recorded party engaged in a phone call to which the mobile data processing apparatus is connected includes determining that there are a plurality of to-be-recorded parties engaged in the phone call to which the mobile data processing apparatus is connected; and
issuing the recording consent notification in accordance with consent requirements of an all-party consent jurisdiction in response to determining that at least one of the to-be-recorded parties is located in an all-party consent jurisdiction.

12. The process of claim 10 wherein determining recording consent notification requirements includes determining a consent jurisdiction of the at least one to-be-recorded party.

13. A mobile data processing apparatus, comprising;
a non-transitory computer-readable medium having an application for implementing a process of generating party-notified phone conversation recordings; and
at least one processor coupled to the non-transitory computer-readable medium for implementing the process of generating party-notified phone conversation recordings, implementing the process of generating party-notified phone conversation recordings includes determining recording consent notification requirements based upon a location of at least to-be-recorded party engaged in a respective one of the phone conversations and issuing recording consent notification to the at least to-be-recorded party in accordance with the consent notification requirements.

14. The mobile data processing apparatuses of claim 13 wherein:
determining recording consent notification requirements based upon a location of at least one to-be-recorded party engaged in a phone call to which the mobile data processing apparatus is connected includes determining that there are a plurality of to-be-recorded parties engaged in the phone call to which the mobile data processing apparatus is connected; and
issuing the recording consent notification in accordance with consent requirements of an all-party consent jurisdiction in response to determining that at least one of the to-be-recorded parties is located in an all-party consent jurisdiction.

15. The mobile data processing apparatuses of claim 13 wherein determining

recording consent notification requirements includes determining a consent jurisdiction of the at least one to-be-recorded party.

16. The mobile data processing apparatuses of claim 13 wherein determining the recording consent notification requirements is performed without human intervention upon the at least one to-be-recorded party being connected to the phone call.

17. The mobile data processing apparatuses of claim 13 wherein implementing the process of generating party-notified phone conversation recordings further comprising:
receiving call recording permission information from the recorded call information server; and
configuring one or more controls of the mobile data processing for enabling a user to selectively initiate and terminate recording of the conversation of the phone call

18. An information capture system, comprising:
a plurality of mobile data processing apparatuses each configured for generating party-notified phone conversation recordings, generating each one of the party-notified phone conversation recordings includes determining recording consent notification requirements based upon a location of at least one party engaged in a respective one of the phone conversations and issuing recording consent notification in accordance with the consent notification requirements; and
a recorded call information server coupled to each one of the mobile data processing apparatuses for monitoring call recording activity of each one of the mobile data processing apparatuses, monitoring the call recording activity includes receiving a location of a particular one of the mobile data processing apparatuses during an instance of a phone call.

19. The information capture system of claim 18 wherein:
determining recording consent notification requirements based upon a location of at least one to-be-recorded party engaged in a phone call to which the mobile data processing apparatus is connected includes determining that there are a plurality of to-be-recorded parties engaged in the phone call to which the mobile data processing apparatus is connected; and
issuing the recording consent notification in accordance with consent requirements of an all-party consent jurisdiction in response to determining that at least one of the to-be-recorded parties is located in an all-party consent jurisdiction.

20. The information capture system of claim 19 wherein:
the recorded call information server provides each one of the mobile data, processing apparatuses with respective call recording permission information;
each one of the mobile data processing apparatuses configures one or more controls for enabling a user to selectively initiate and. terminate recording of the phone call conversations.
